(19) United States
(12) Patent Application Publication
(10) Pub. No.: US 2018/0340621 A1
(43) Pub. Date: Nov. 29, 2018

(54) Four-Way Modulation Valve

(71) Applicant: Mingsheng Liu, Omaha, NE (US)

(72) Inventor: Mingsheng Liu, Omaha, NE (US)

(21) Appl. No.: 15/607,660

(22) Filed: May 29, 2017

(51) Int. Cl. F16K 11/02; F16K 11/044

(52) U.S. Cl. CPC F16K 11/02; F25B 49/022; F16K 11/044

(57) ABSTRACT

A four-way modulation valve device to reverse, to block, and to control/modulate air, water, and liquid flow in pipelines. The valve and device involves the use air, water, and liquid back flushing the systems (filter, heat exchangers, and others), reversing flow (heat pump and others), and flow modulation (heat exchangers and other industrial devices). In an embodiment, the four-way modulation valve consists of X-shape plug, cylindrical enclosure, four ports for primary and secondary system connection, and four pressure ports for sensors and actuator connection. The four-way modulation valve has both traditional four way valve and control valve function. Replacing existing control valve with the four-way modulation valve will add back flushing and system isolation function to the existing system. Installing four-way modulation valve in a system will eliminate the need of control valve. Four-way modulation valves significantly improve the system performance and reduce the equipment and engineering cost as well.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relates to reversing the flow, back flushing, and controlling the flow in water, liquid, and gas distribution piping systems, water heating systems, cooling systems, refrigeration systems, and industrial heat exchangers.

### DESCRIPTION OF THE RELATED ART

Back flushing and/or reverse flowing are essential for filter and heat exchanger cleaning, and special engineered system, such as heat pumps. These functions are achieved often by so called four-way valve or four-way cock. The four-way valve or four-way cock is a fluid control valve whose body has four ports equally spaced round the valve chamber and the plug has two passages to connect adjacent ports. The plug may be cylindrical or tapered, or a ball. It has two flow positions, and usually a central position where all ports are closed. Because the two “L”-shaped ports in the plug do not interconnect, the four-way valve is sometimes referred to as an “x” port or X-body.

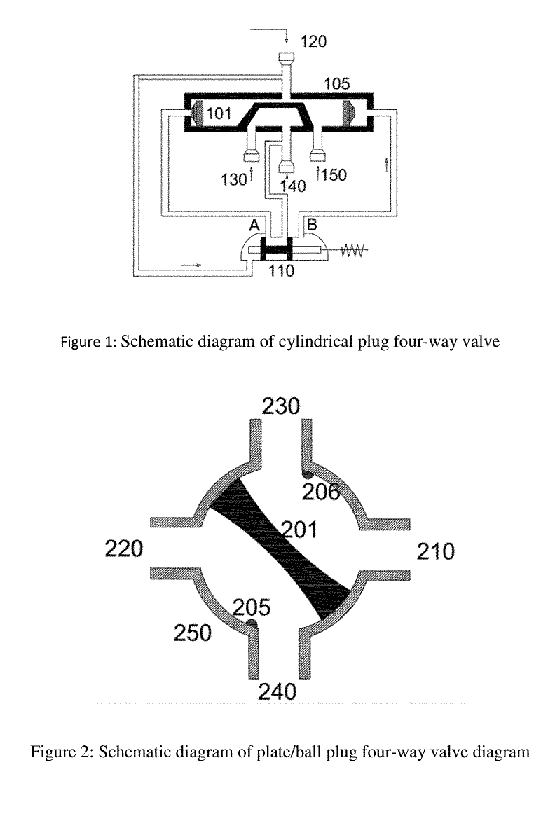

FIG. 1 presents the schematic of the cylindrical four-way valves for heat pump application. It consists of four-way pilot 110, cylinder 101, compressor port 120, outdoor port 130, return port 140, and indoor port 150. During heating mode, the four-way pilot 110 connect the compressor discharge pressure to the right side of the cylinder 101, and the suction pressure to the left side of the cylinder 101. Under the pressure difference, the cylinder 101 is pushed to the left side. Hot and high pressure gas is sent to the indoor unit through compressor port 120 and indoor port 150. The outdoor units and indoor units are connected through outdoor port 130 and the return port 140. In cooling mode, the four-way pilot 101 sends the hot and high pressure gas to the left side of the cylinder 101, and low suction gas to the right side of the cylinder 101. The cylinder 101 is pushed to the right side. The hot and high pressure gas is sent to the outdoor unit through compressor port 120 and outdoor port 130. The hot and high pressure gas is cooled in the condenser as liquid. The four-way valve 100 connects the indoor units and the suction of the compressor through indoor port 150 and the return port 140. The function of the cylindrical four-way valves are limited to reverse flow only.

FIG. 2 presents the schematic of the typical X-body four-way valves. It consists of a plug 201, position pins 205 and 206, inlet port 210, outlet port 220, left load port 230, and the right load port 240. The ball plug is limited to small valves due to its cost. The four-way ball plug valve can reverse the water or air flow on the load side, block the flow, and even be able to modulate the flow although it is not designed to do so.

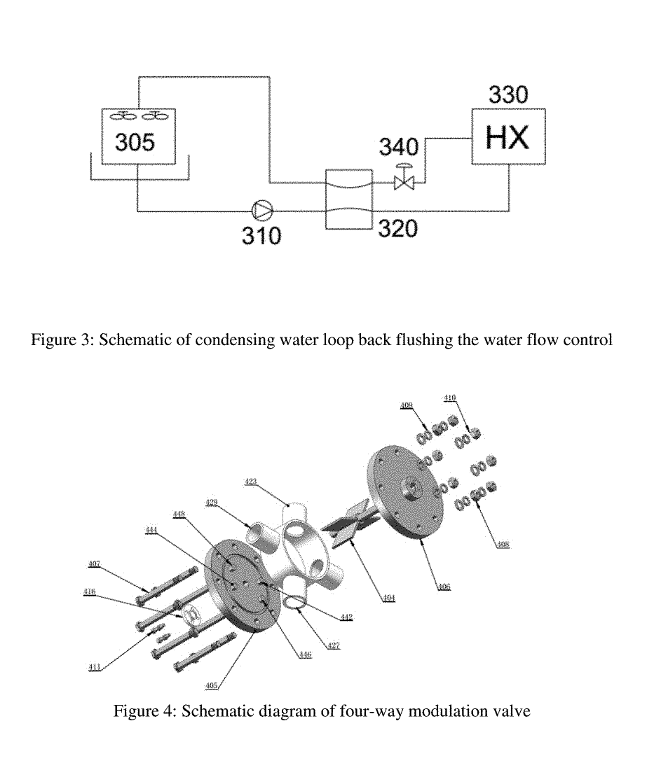

For large valves, plate plugs have to used. The four-way plate plug valves can only reverse the flow. It is impossible to block the flow and modulate the flow. Both of these functions are essential for all engineering systems. FIG. 3 presents a typical heat exchanger system, which includes cooling tower 305, cooling water pump 310, four-way reverse valve 320, condenser heat exchanger 330, and control valve 340. The four-way valve 320 serves the purpose of back flushing the heat exchanger. The control valve 340 modulates the water flow rate to satisfy the heat exchanger's need. If the four-way valves can be used as modulation, the control valve can be eliminated.

In order to simply the system structure, to improve the flow control, a novel four-way control valve is described in the application. The proposed embodiment differs from the prior arts in that (1) a X-shape plug is used and the following parts are added: supply water port, return water port, and load side ports; and (2) water flow modulation in addition to the reversing the flow and blocking the flow.

The proposed embodiment adds the water/air flow modulation/control function to the four-way valves. It integrates flow control, flow reverse, and flow elimination into a single valve: four-way modulation vale.

It is therefore one aspect of an embodiment to remove the existing control valves in engineered systems. This will results in significant amount of energy savings due to reduced pressure loss and system cost due to eliminated existing control valve.

It is therefore one aspect of an embodiment to improve the control performance due to double disk structure, which add resistance to both inlet and outlet resistance when it is not full open. It is critical and importance feature when the system resistance is excessive.

It is therefore one aspect of an embodiment to have the minimal valve size for the same port pipe diameter.

It is further one aspect of an embodiment to have the minimal torque requirement of the actuator due to the X-shape plug.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In an embodiment, an four-way modulation valve and method for water/liquid and air is provided. The four-way modulation valve consists of X-Shaped plug 401, cylinder enclosure 402, supply port 423, return port 427, load side ports 425 and 429, bottom plate 405, top plate 406, supply pressure port 448, return pressure port 446, load side pressure ports 442 and 444, shaft seal 416, 8 fastener bolt 407, 8 fastener washer 408, 8 fastener ring 409, 8 hexagon lock 410, and 4 fastener screw 411.

The X-shaped plug allows to reverse the flow: connecting supply port 423 to load side port 429 or port 425; to block the flow: move the X-shaped plug 401 to seal the supply port 423 and the return port 427, or to seal the load side ports 425 and 429; and to modulate the flow: to change the cross sections of the supply and return port 423 and 427 to the cylinder 402. The X-shaped plug functions as a double disk control valve when it is used to control the flow. For example, the X-shaped plug blocked the 50% of passing section from the supply port to the enclosure cylinder. At the same time, it also blocked 50% of the passing section from the cylinder 402 to the return port 427. The X-shaped plug provides superior control performance than the butterfly valves, which are often used for large size valves.

The above-described summary, features, and advantages of the present disclosure thus improve upon aspects of those systems and methods in the prior art designed to release air from water/liquid distribution system or pipelines.

### DRAWINGS REFERENCE NUMERALS

100 Schematic diagram of cylindrical plug four-way valve
101 Cylindrical plug
105 Cylinder
110 Four-way pilot
120 Supply port
130 Load side port
140 Return port
150 Load side port
200 Schematic diagram of plate/ball plug four-way valve diagram
201 Plate or ball plug
205 Position pin for plate plug
206 Position pin for plate plug
210 Supply port
220 Return port
230 Load side port
240 Load side port
250 Valve enclosure
300 Schematic of condensing water loop back flushing the water flow control
305 Cooling tower
310 Water pump
320 Four-way valve
330 Condenser heat exchanger
340 Control valve
400 Schematic diagram of four-way modulation valve
402 Cylinder enclosure
404 X-shaped plug
405 Bottom plate
406 Top plate
407 Fastener bolt (4)
408 fastener washer (8)
409 Fastener washer ring (8)
410 Hexagon lock (8)
411 Fastener screw (4)
416 Shaft seal
423 Supply port
425 Load side port
427 Return port
429 Load side port
442 Supply pressure port
444 Return pressure port
446 Load side pressure port
448 Load side pressure port

### BRIEF DESCRIPTION OF THE DRAWINGS

It will be appreciated that for simplicity and clarity of illustration, elements illustrated in the following figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is prior art cylindrical four-way valve principal schematic diagram

FIG. 2 is prior art ball/plate plug four-way valve principal schematic diagram

FIG. 3 is schematic of typical condenser cooling water back flushing and flow control schematic diagram

FIG. 4 is a schematic diagram of the system embodying the principles of the invention used for water and/or liquid distribution pipeline systems.

### DETAILED DESCRIPTION

Before the present methods, systems, and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. Nothing herein is to be construed as an admission that the embodiments described herein are not entitled to antedate such disclosure by virtue of prior invention.

Four-way modulation valve device 400 is illustrated in FIG. 4. It can be used for (1) back flushing heat exchangers, filters, and any other device where back flush clean is required; (2) reverse the flow, such as heat pump operation (switching from heating to cooling and vice versa); (3) block the flow and isolate the load side system from the supply side; and (4) modulate/control flow to maintain required control performance and target.

Four-way modulation valve 400 is connected to the primary supply by the supply port 423; return side by the return port 427, is connected to the load side by the load side ports 425 and 429. Supply and return port 423 and 427 connections are interchangeable. Load side port 425 and 429 connections are also interchangeable.

To block or isolate the primary and the secondary system, position the X-shaped plug 404 to seal both supply and the return ports 424 and 427. It can also be performed by position the X-shaped plug 404 to seal the load side ports 425 and 429.

To supply liquid to load side port 425, position the X-shaped plug tip in between the port 423 and 429.

To reverse the flow or to supply liquid to load side port 429, position the X-shaped plug tip in between ports 423 and 425.

To modulate or control the flow, rotate/change the passing cross section between the supply port 423 and the cylinder 402. When the passing cross section is changed, the same amount of cross section occurs between the return port 427 and the cylinder 402. The four-way modulation valve has the double disk modulation effect. The flow modulation can also performed by changing the pass cross section between the load side ports 425, 429 and the cylinder 402.

Pressure ports 442, 444, 446, 448 provide easy access and/or installation of pressure sensors, temperature sensors, and connection to the hydronic actuator. This makes the control implementation easy.

It will be apparent to those skilled in the art that various modifications can be made in the system for reversing, blocking/isolating, and modulating water, liquid, and gas flow without departing from the scope or spirit of the given embodiment. Other embodiments will be apparent to those skilled in the art from consideration of the specification and practice of the disclosure in this application.

What is claimed is:

1. A four-way modulation valve for reversing flow, blocking the flow, and modulating/control flow of air, water, and liquid, said four-way modulation valve device for a pipeline comprising:
at least four connection ports;
at least one cylindrical enclosure;
at least one bottom plate and one top plate;
at least one X-shaped plug;
at least four pressure ports.

2. The four-way modulation valve device of claim 1, wherein said air, water, and liquid for the pipeline is an air distribution pipeline.

3. The four-way modulation valve device of claim 1, wherein said air, water, and liquid for the pipeline is a water distribution pipeline.

4. The four-way modulation valve device of claim 1, wherein said air, water, and liquid for the pipeline is chemical or industrial fluid distribution pipeline.

5. The four-way modulation valve device of claim 1, wherein said vacuum tank is a tank equipped and connected to a vacuum pump.

6. The four-way modulation valve device of claim 1, wherein said X-shaped plug has a tip which can cover the entire pipe port cross section.

7. The four-way modulation valve device of claim 1, wherein said bottom plate is an end-cover of the cylindrical enclosure, and can be built together with the cylindrical enclosure.

8. The four-way modulation valve device of claim 1, wherein said top plate is an end-cover of the cylindrical enclosure and can be built together with the cylindrical enclosure.

9. The four-way modulation valve device of claim 2, wherein said flow modulation is performed by changing the passing cross section areas of supply and return ports and the cylindrical enclosure using the X-shape plug.

10. The four-way modulation valve device of claim 2, wherein said flow modulation is performed by changing the passing cross section areas of load side ports and the cylindrical enclosure using the X-shape plug.

11. The four-way valve modulation device of claim 3, wherein said pressure ports are direct access of pressure, temperature, and water/air/liquid mechanism.

12. The four-way valve modulation device of claim 3, where said ports provide easy temperature and pressure sensor installation, and direct connection with a hydronic actuators.
